(19) United States
(12) Patent Application Publication
(10) Pub. No.: US 2025/0103862 A1
(43) Pub. Date: Mar. 27, 2025

(54) SYSTEMS AND METHODS FOR EFFICIENT COMPUTATIONS FOR DEEP NEURAL NETWORK LAYERS WITH REPETITIVE WEIGHTS

(71) Applicant: Robert Bosch GmbH, Stuttgart (DE)

(72) Inventors: MOHAMMAD SADEGH NOROUZZADEH, PITTSBURGH, PA (US); SHAHBAZ REZAEI, DAVIS, CA (US)

(21) Appl. No.: 18/471,531

(22) Filed: Sep. 21, 2023

(51) Int. Cl. G06N 3/0464

(52) U.S. Cl. CPC G06N 3/0464

(57) ABSTRACT

A method for neural network computations. The method includes receiving a codebook having a plurality of entries, multiplying a respective input of a layer of a neural network by each entry of the plurality of entries of the codebook, and determining, for the respective input of the layer of the neural network, an intermediate value based on a sum of each result of multiplying the respective layer of the neural network by each entry of the plurality of entries of the codebook. The method also includes storing the intermediate value associated with the respective input of the layer of the neural network in a lookup table, the lookup table including a plurality of intermediate values corresponding to other inputs of the layer of the neural network. The method also includes determining each output of the layer of the neural network using the lookup table.

### TECHNICAL FIELD

The present disclosure relates to deep neural networks, and in particular to systems and methods for efficient computations for deep neural network layers having repetitive weights.

### BACKGROUND

Deep neural networks have proven to be remarkably powerful tools for various tasks, ranging from image and speech recognition to natural language processing. However, such networks vast number of parameters, may pose challenges. For example, typical deep neural networks consist of millions, and in some cases, multiple billions of learnable parameters, making such networks computationally demanding and resource-intensive to train and deploy.

### SUMMARY

An aspect of the disclosed embodiments includes a method for neural network computations. The method includes receiving a codebook having a plurality of entries, multiplying a respective input of a layer of a neural network by each entry of the plurality of entries of the codebook, and determining, for the respective input of the layer of the neural network, an intermediate value based on a sum of each result of multiplying the respective layer of the neural network by each entry of the plurality of entries of the codebook. The method also includes storing the intermediate value associated with the respective input of the layer of the neural network in a lookup table, the lookup table including a plurality of intermediate values corresponding to other inputs of the layer of the neural network. The method also includes determining each output of the layer of the neural network using the lookup table.

Another aspect of the disclosed embodiments includes a system for neural network computations. The system includes a processor, and a memory. The memory includes instructions that, when executed by the processor, cause the processor to: receive a codebook having a plurality of entries; multiply a respective input of a layer of a neural network by each entry of the plurality of entries of the codebook; determine, for the respective input of the layer of the neural network, an intermediate value based on a sum of each result of multiplying the respective layer of the neural network by each entry of the plurality of entries of the codebook; store the intermediate value associated with the respective input of the layer of the neural network in a lookup table, the lookup table including a plurality of intermediate values corresponding to other inputs of the layer of the neural network; and determine each output of the layer of the neural network using the lookup table.

Another aspect of the disclosed embodiments includes an apparatus that includes a processor, and a memory. The memory includes instructions that, when executed by the processor, cause the processor to: retrieve a codebook having a plurality of entries and a dimension corresponding to a number of inputs of a layer of a neural network, wherein the neural network includes a vector-quantized deep neural network; multiply a respective input of the layer of the neural network by each entry of the plurality of entries of the codebook; determine, for the respective input of the layer of the neural network, an intermediate value based on a sum of each result of multiplying the respective layer of the neural network by each entry of the plurality of entries of the codebook; store the intermediate value associated with the respective input of the layer of the neural network in a lookup table, the lookup table including a plurality of intermediate values corresponding to other inputs of the layer of the neural network; and determine each output of the layer of the neural network using the lookup table.

### BRIEF DESCRIPTION OF THE DRAWINGS

FIG. 1 generally illustrates a system for training a neural network, according to the principles of the present disclosure.

FIG. 2 generally illustrates a computer-implemented method for training and utilizing a neural network, according the principles of the present disclosure.

FIG. 3 generally illustrates aspects of a neural network computations technique, according to the principles of the present disclosure.

FIG. 4 is a flow diagram generally illustrating a neural network computations method, according to the principles of the present disclosure.

FIG. 5 depicts a schematic diagram of an interaction between a computer-controlled machine and a control system, according to the principles of the present disclosure.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to the principles of the present disclosure.

FIG. 7 depicts a schematic diagram of the control system of FIG. 5 configured to control a manufacturing machine, such as a punch cutter, a cutter or a gun drill, of a manufacturing system, such as part of a production line.

FIG. 8 depicts a schematic diagram of the control system of FIG. 5 configured to control a power tool, such as a power drill or driver that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example an MRI apparatus, x-ray imaging apparatus or ultrasonic apparatus.

FIGS. 12A and 12B illustrate an example vectorization of a quantized linear layer, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

As described, deep neural networks have proven to be remarkably powerful tools for various tasks, ranging from image and speech recognition to natural language processing. However, such networks vast number of parameters, may pose challenges. For example, typical deep neural networks consist of millions, and in some cases, multiple billions of learnable parameters, making such networks computationally demanding and resource-intensive to train and deploy.

Accordingly, systems and methods, such as the systems and methods described herein, configured to provide efficient computations for deep neural network layers, may be desirable. In some embodiments, the systems and methods described herein may be configured to accelerate computations in deep neural network layers (e.g., at least when the weights exhibit repetitive patterns). The systems and methods described herein may be configured to provide efficient computations for layers of any suitable neural network such as vector-quantized deep neural networks and/or any other suitable neural networks.

In some embodiments, the systems and methods described herein may be configured to account for a high parameter count. For example, the size of deep neural networks may be a double-edged sword. In some embodiments, a large number of parameters may enable complex modeling and better representation of intricate patterns in data, but also may lead to heavy memory usage and computational overhead.

The systems and methods described herein may be configured to account for a parameter redundancy. In some embodiments, deep neural networks may exhibit parameter redundancy, implying that not all the parameters are utilized optimally during inference. In some embodiments, this redundancy may highlight an inefficiency in the network's architecture, where a portion of the parameters might not contribute significantly to the model's predictive performance.

The systems and methods described herein may be configured to account for pruning techniques to address parameter redundancy. In some embodiments, the systems and methods described herein may incorporate various pruning techniques. The systems and methods described herein may utilize these techniques to remove or set certain parameters to zero, which may reduce the model's parameter count. In some embodiments, pruning can lead to more compact models, better resource utilization, reduced memory footprint, and improved inference speed. Further, pruning may potentially result in models that are more interpretable and easier to comprehend.

The systems and methods described herein propose a novel approach to address the problem of high parameter counts in deep neural networks. The systems and methods described herein may be configured to leverage the concept of vector quantization to enable the utilization of a reduced number of parameters in deep neural networks. By employing vector quantization, the systems and method described herein may be configured to capture the essential information of the original parameters while reducing their overall size.

The systems and methods described herein may be configured to strike a balance between model complexity and efficiency. Although there may be a small computational overhead during the training phase, by utilizing vector quantization to reduce the number of parameters while preserving model performance, the systems and methods described herein may be configured to achieve more resource-efficient deep neural networks at inference time. The systems and methods described herein may be configured to improve computational resource utilization, reduce inference latency, and facilitate the development of more interpretable models, contributing to the wider adoption of deep learning techniques in real-world applications.

The systems and methods described herein introduce techniques that set it apart from existing approaches, which may enhance effectiveness and versatility in addressing the challenges of parameter count, computational efficiency, and model explainability.

The systems and methods described herein may be configured to utilize a global codebook for multiple layers. Unlike many other existing approaches that employ individual codebooks for each layer, the systems and methods described herein utilize a single global codebook for all layers of the same type in a deep neural network. The systems and methods described herein may demonstrate that enforcing the same codebook on all layers may not degrade the performance and the model can reuse the same codebook to perform the same task. The systems and methods described herein may lead to a reduction in the overall number of parameters required for vector quantization. By sharing a common codebook across multiple layers, the systems and methods described herein reduce parameter redundancy and effectively compress the model, which may result in more compact and resource-efficient model.

The systems and methods described herein may be configured to be compatible with existing techniques. An advantage of the systems and methods described herein is the non-conflicting nature with numerous other existing techniques. The systems and methods described herein may be a complementary approach that can integrate with various pruning, weight sharing, and other parameter reduction or quantization approaches. In some embodiments, compatibility ensures that the systems and methods described herein may be used as a foundational framework upon which other advanced techniques may be applied, further enhancing the efficiency and performance of deep neural networks.

The systems and methods described herein may be configured to improved pruning efficiency. In some embodiments, the small codebook size used in the systems and methods described herein may lead to parameter redundancy within the network. This redundancy, which arises due to the shared codebook, may provide an inherent mechanism that facilitates the efficiency of existing pruning techniques. During the pruning process, the redundant parameters may be naturally identified and eliminated, resulting in a more streamlined model without sacrificing performance. Consequently, the systems and methods described herein may not only directly reduce the parameter count through vector quantization but also may indirectly improve the efficiency of subsequent pruning procedures.

The systems and methods described herein may be configured to capitalize on these improvements and may present a solution to the challenges posed by large parameter counts in deep learning models. In some embodiments, the use of a global codebook, compatibility with other techniques, and the potential for enhanced pruning efficiency collectively may make the systems and methods described herein a compelling choice for researchers and practitioners seeking to develop resource-efficient, interpretable, and high-performance deep neural networks.

The systems and methods described herein may be configured to enhance edge computing and internet of things devices (IoT). Edge computing and IoT devices often have limited computational resources and memory. The systems and methods described herein may include an ability to significantly reduce the parameter count and be particularly well-suited for deploying deep neural networks on resource-constrained devices. In some embodiments, by compressing models without compromising their performance, the systems and methods described herein enable efficient and low-latency AI processing at the edge, allowing for real-time inference and smart decision-making in IoT applications.

The systems and methods described herein may be configured to enhance mobile and wearable devices. Mobile phones, wearables, and other portable devices may be becoming increasingly popular platforms for AI-based applications. However, the computational limitations of these devices make it challenging to run large and complex deep neural networks. The systems and methods described herein may facilitate the deployment of sophisticated AI models on mobile and wearable devices by reducing the memory footprint and computational requirements, and may enhance the user experience of AI-powered applications.

The systems and methods described herein may be configured to enhance interpretable AI systems. In applications where interpretability is crucial, such as medical diagnosis, finance, and legal domains, the systems and methods described herein offer the advantage of having a great deal of redundancy in network weights.

The systems and methods described herein may be configured to address the pressing need for efficient, interpretable, and real-world applicable AI models. In some embodiments, the systems and methods described herein may reduce parameter count by employing a global codebook for multiple layers, improving resource efficiency and model interpretability. The compatibility of the systems and methods described herein with other techniques may allow seamless integration and further optimization. The systems and methods described herein may align with the growing demands for edge computing, IoT devices, and interpretable AI, while considering advancements in deep learning hardware.

The systems and methods described herein builds upon principles from both data compression and deep learning. Unlike conventional approaches that use individual codebooks for each layer, the systems and methods described herein employ a single global codebook for multiple layers, reducing parameter redundancy and model complexity. Additionally, the systems and methods described herein may be compatible with existing techniques which may allow for smooth integration, enabling further optimization, and improvement. The systems and methods described herein may be configured to offer a novel solution to enhance model efficiency, interpretability, and applicability in various deep learning domains.

The systems and methods described herein may be configured to utilize vector quantization which is a data compression technique that may represent a set of data points using a smaller number of representative vectors called codewords. The systems and methods described herein may be configured to create a codebook, which is a collection of codewords that represent clusters of similar data points. The systems and methods described herein may be configured to divide the data space into non-overlapping regions, with each region associated with a specific codeword from the codebook. In some embodiments, during encoding each data vector (e.g., model parameters) may be mapped to the nearest codeword, which may effectively quantizing the data. In some embodiments, during decoding the original data may be reconstructed by using the corresponding codeword from the codebook.

The systems and methods described herein may be configured to introduce vector quantization to deep neural networks by partitioning the parameters of each layer into non-overlapping regions, tailored to the layer type. For 2D convolution layers, the systems and methods described herein divide the weight matrix over the channel input and channel output dimensions. For example, the weight matrix is of shape (Cout, Cin, K, K). The systems and methods described herein may be configured to divide the weight matrix into Cout*Cin/L regions of size K*K*L. This partitioning strategy may be effective for modern deep neural networks, since they frequently utilize 1×1, 3×3, and 2D convolution layers.

The systems and methods described herein may be configured to determine the size of each codebook. For example, E may be used as a hyperparameter to define the number of codewords in each codebook. The hyperparameter may be tuned to optimize the model's performance. Furthermore, E may vary for each type of layer, but the systems and methods described herein may be configured to utilize E=16 which offers excellent results across various use cases.

Regarding the bias parameters of the layers, the systems and methods described herein may implement one of two viable options. The first option is to treat the bias parameters as done in ordinary neural networks, by not including them in the vector quantization process. In some embodiments, this approach may be suitable since the number of bias parameters is significantly lower than the number of weight parameters in most cases. As a result, ignoring biases does not compromise the effectiveness of the vector quantization technique. Regarding the second option, the systems and methods described herein may divide the bias parameters into multiple partitions, similar to how linear layers are handled. By doing so, the systems and methods described herein may subject the bias parameters to the same quantization process.

The systems and methods described herein may be configured to apply vector quantization to a deep neural network during the training phase. At the forward pass, the systems and methods described herein may quantize the weights of each supported layer using the respective codebooks until the last layer of the network. In some embodiments, the quantization process involves finding the nearest codeword in the codebook for each partition in the weights matrix and replacing the original weights with the corresponding codeword and then performing the convolution operation.

The systems and methods described herein may be configured to, upon reaching the last layer, compute the loss value, which may consists of two components. The first component may be the normal loss of the network, such as the cross-entropy loss for classification tasks. The second component may be the distance between the quantized weights and the values inside the codebook. This distance component may serve as a regularization term that encourages the model to adhere to the representative codewords in the codebook. This loss component may be independently computed for each layer and separately applied to both codebook values and the weights of each layer.

The systems and methods described herein may be configured to, during the backward pass, at each layer, pass the received gradient from the next layer to the previous layer, allowing the model to learn efficiently from the quantized representations.

In some embodiments, the systems and methods described herein may be configured to accelerate neural network computations by leveraging repetitive patterns present in network weights. The systems and methods described herein may be configured to address the challenge of redundancy in computations, to capitalize on the reuse of previously calculated results. The systems and methods described herein may be configured to uses weights of each layer that originate from a compact codebook, resulting in multiple occurrences of each code within the codebook, which may be applicable to vector-quantized deep neural networks and other techniques, such as product-quantization.

The systems and methods described herein may be configured to exploit the recurrent presence of codes, to optimize the computation process, reducing redundant calculations, and promoting efficiency. The systems and methods described herein may be configured to effectively capitalizes on the reuse of intermediate results, thereby significantly speeding up the overall inference and training phases of neural networks.

The systems and methods described herein may be configured to reduce floating-point operations (FLOPs) for layers commonly found in deep learning architectures. The systems and methods described herein may be configured to, by leveraging advanced computation optimization techniques, reduce the number of FLOPs significantly, which may directly translate to faster inference time, making it invaluable for resource-constrained environments, such as edge devices and mobile platforms. The systems and methods described herein may be configured to avoid redundant calculations and reuse previously computed results efficiently by identifying and exploiting repetitive patterns and redundancies in layer computations. The systems and methods described herein may be configured to allow for seamless integration into various deep learning architectures, ensuring consistent FLOP reductions across diverse tasks and applications.

The systems and methods described herein may be configured to improve computations in resource-constrained environments. The systems and methods described herein may be configured to allow for artificial intelligence (AI) adoption in remote locations, embedded systems, and edge computing scenarios, where resources are limited.

The systems and methods described herein may be configured to provide for improved model development speed. The systems and methods described herein may be configured to reduced computational overhead, which may boost productivity in AI research, enabling rapid progress in the field.

The systems and methods described herein may be configured to provide energy-efficient AI. The systems and methods described herein may be configured to reduce computational demands, which may benefit large-scale AI deployments, reducing power consumption and promoting greener AI infrastructures.

The systems and methods described herein may be configured to provide improvements to the use of real-time AI applications. The systems and methods described herein may be configured to improve real-time object detection, natural language processing, and autonomous systems based on efficiency gains provided herein, which may ensure faster and more accurate responses in dynamic environments.

In some embodiments, the systems and methods described herein may be configured to introduce a streamlined computation approach to accelerate the performance of vector-quantized deep neural networks. The systems and methods described herein may be configured to, by optimizing computations, reduce memory usage and computational power requirements for running vector-quantized deep neural networks at inference time, enabling resource-efficient and high-performing AI calculations.

In some embodiments, the systems and methods described herein may be configured provides efficient computations for deep neural networks with repetitive weights, particularly in the context of vector-quantized deep neural networks. The systems and methods described herein may be configured to use of a relatively small codebook to represent the weights, which may be significantly smaller than the original weights and feature substantial repetition (e.g., which may align well with vector-quantized deep neural networks, where compact codebooks and repeated codewords are common).

The systems and methods described herein may be configured to modify conventional computations in deep neural networks. The systems and methods described herein may be configured to, rather than directly computing the product (e.g., or performing a convolution operation) of weights with the inputs, the systems and methods described herein may be configured to multiply (e.g., or convolve) the entire codebook with the inputs. As the codebook is much smaller than the original weights, these computations can be performed significantly faster. The systems and methods described herein may be configured to, for each repetitive partition of the weights, retrieve the results from the first step for the corresponding codeword and concatenate the results to generate the desired results.

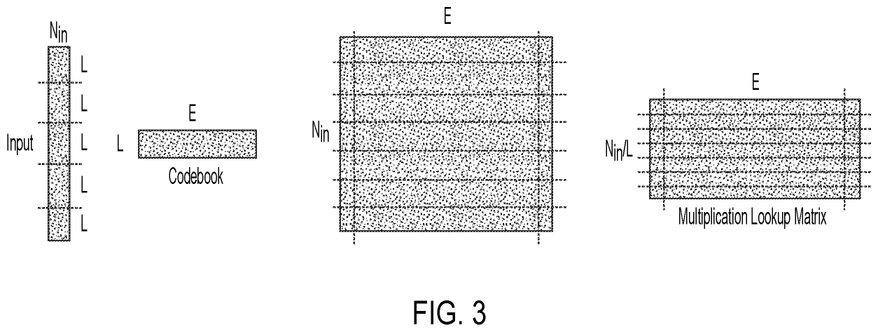

For example, as is generally illustrated in FIG. 3, for linear layers (e.g., where other types of layers correspond to a similar technique), consider a linear layer with Nᵢₙ*Nₒᵤₜ parameters and batch size of np. In the conventional approach, the weight matrix is multiplied with the inputs and the results are summed along the output dimension, yielding an N_{b}*Nₒᵤₜ output. Hence, it consumes N_{b}*Nᵢₙ*Nₒᵤₜ Flops. In some embodiments, the systems and methods described herein may be configured to maintain a codebook containing E entries of size L. The systems and methods described herein may be configured to construct the weight matrix W by storing Nₒᵤₜ*(Nᵢₙ/L) indexes to the codebook. Each index may include an integer number between 1 to E, and consequently, uses a single byte of storage (e.g., which is contrasted with a 4-bytes or 8-byte weight values, of the conventional approach). The systems and methods described herein may be configured to multiply the input by the entire codebook and sum along the L dimension, resulting in a N_{b}*(Nᵢₙ/L)*L*E Flops and an output of size N_{b}*(Nᵢₙ/L)*E, called R. The entire computation is reduced to a lookup from R. The systems and methods described herein may be configured to construct a matrix of size N_{b}*Nₒᵤₜ*(Nᵢₙ/L) by a look-up from R and sum along the output dimension, resulting in the output of size N_{b}*Nₒᵤₜ. Hence, the overall Flops is N_{b}*Nᵢₙ*(E+Nₒᵤₜ/L). For example, for a linear layer of size 768*768, the systems and methods described herein, using a codebook of 16 entries with L=8, may reduce the Flops by a factor of around 6.8.

By leveraging this technique, the systems and methods described herein may be configured to achieve significant computational efficiency for vector-quantized deep neural networks. The reduction in computations allows for faster inference times, providing an invaluable tool for resource-efficient and high-performing AI applications in diverse real-world scenarios.

In some embodiments, the systems and methods described herein may be configured to provide neural network computations. The systems and methods described herein may be configured to receive a codebook having a plurality of entries. The codebook may include dimension corresponding to a number of inputs of the layer of the neural network. Each entry of the plurality of entries of the codebook may correspond to an index value. Each index value may include an integer between 1 and an upper limit. The upper limit may correspond to a total number of entries of the plurality of entries of the codebook. The respective layer of the neural network may include one of a plurality of linear layers of the neural network. The respective layer of the neural network may include a fully connected layer. The neural network may include a convolutional neural network, a vector-quantized deep neural network, or other suitable network. The neural network may be associated with controlling at least one aspect of a vehicle and/or any other suitable application described herein and/or any other suitable application.

The systems and methods described herein may be configured to multiply a respective input of a layer of a neural network by each entry of the plurality of entries of the codebook. The systems and methods described herein may be configured to determine, for the respective input of the layer of the neural network, an intermediate value based on a sum of each result of multiplying the respective layer of the neural network by each entry of the plurality of entries of the codebook.

The systems and methods described herein may be configured to store the intermediate value associated with the respective input of the layer of the neural network in a lookup table. The lookup table may include a plurality of intermediate values corresponding to other inputs of the layer of the neural network. The systems and methods described herein may be configured to determine each output of the layer of the neural network using the lookup table.

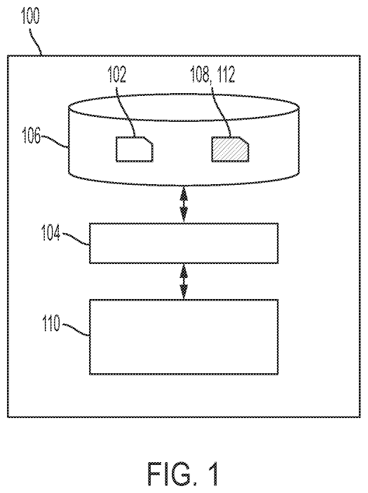

FIG. 1 shows a system 100 for training a neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104.

In some embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers.

The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network.

The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In some embodiments, the data representation 112 may be stored separately from the data representation 108 defining the ‘untrained’ neural network. In some embodiments, the output interface may be separate from the data storage interface 104, but may in general be of a type as described above for the data storage interface 104.

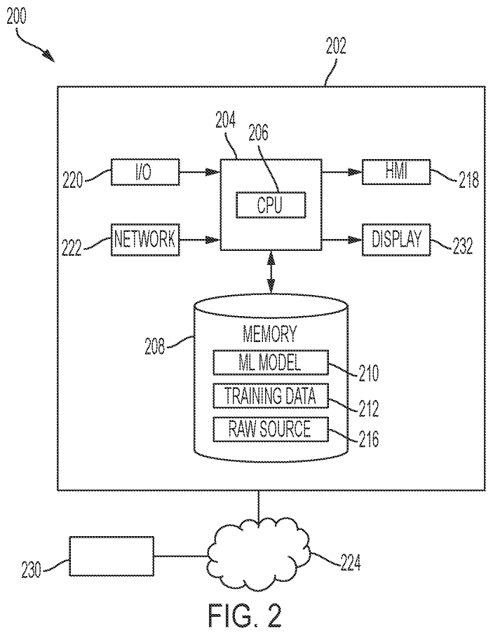

FIG. 2 generally illustrates a data annotation/augmentation system 200 configured to provide embodied multimodal artificial intelligence question answering. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction stet such as one of the x86, ARM, Power, or MIPS instruction set families.

During operation, the CPU 206 may execute stored program instructions that are retrieved from the memory unit 208. The stored program instructions may include software that controls operation of the CPU 206 to perform the operation described herein. In some embodiments, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 (e.g., represented in FIG. 2 as the ML Model 210) or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning model 210 (e.g., which may be referred to as the machine-learning algorithm 210) that is configured to analyze the raw source dataset 216. The raw source dataset 216 may include raw or unprocessed sensor data that may be representative of an input dataset for a machine-learning system. The raw source dataset 216 may include video, video segments, images, text-based information, and raw or partially processed sensor data (e.g., radar map of objects). In some embodiments, the machine-learning model 210 may be a neural network algorithm that is designed to perform a predetermined function. For example, the neural network algorithm may be configured in automotive applications to identify pedestrians in video images.

The computer system 200 may store a training dataset 212 for the machine-learning model 210. The training dataset 212 may represent a set of previously constructed data for training the machine-learning model 210. The training dataset 212 may be used by the machine-learning model 210 to learn weighting factors associated with a neural network algorithm. The training dataset 212 may include a set of source data that has corresponding outcomes or results that the machine-learning model 210 tries to duplicate via the learning process.

The machine-learning model 210 may be operated in a learning mode using the training dataset 212 as input. The machine-learning model 210 may be executed over a number of iterations using the data from the training dataset 212. With each iteration, the machine-learning model 210 may update internal weighting factors based on the achieved results. For example, the machine-learning model 210 can compare output results (e.g., annotations) with those included in the training dataset 212. Since the training dataset 212 includes the expected results, the machine-learning model 210 can determine when performance is acceptable. After the machine-learning model 210 achieves a predetermined performance level (e.g., 100% agreement with the outcomes associated with the training dataset 212), the machine-learning model 210 may be executed using data that is not in the training dataset 212. The trained machine-learning model 210 may be applied to new datasets to perform any suitable functions of any of the applications described herein or other suitable applications.

The machine-learning model 210 may be configured to identify a particular feature in the raw source data 216. The raw source data 216 may include a plurality of instances or input dataset for which various predictions are desired. The machine-learning model 210 may be programmed to process the raw source data 216 to identify the presence of the particular features. The machine-learning model 210 may be configured to predict, using the raw source data 216, one or more answers to one or more questions. The raw source data 216 may be derived from a variety of sources. For example, the raw source data 216 may be actual input data collected by a machine-learning system. The raw source data 216 may be machine generated for testing the system.

In the example, the machine-learning model 210 may process raw source data 216 and output a prediction. The machine-learning model 210 may generate a confidence level (e.g., a certainty value) or factor for each output generated. For example, a confidence value that exceeds a predetermined high-confidence threshold may indicate that the machine-learning model 210 is confident that the prediction will result in a desired outcome. A confidence value that is less than a low-confidence threshold may indicate that the machine-learning model 210 has some uncertainty that the prediction will result in the desired outcome.

In some embodiments, the system 200 may, provide neural network computations. The system 200 may receive a codebook having a plurality of entries. The codebook may include dimension corresponding to a number of inputs of the layer of the neural network associated with the machine-learning model 210. Each entry of the plurality of entries of the codebook may correspond to an index value. Each index value may include an integer between 1 and an upper limit. The upper limit may correspond to a total number of entries of the plurality of entries of the codebook. The respective layer of the neural network may include one of a plurality of linear layers of the neural network. The respective layer of the neural network may include a fully connected layer. The neural network may include a convolutional neural network, a vector-quantized deep neural network, or other suitable network. The neural network may be associated with controlling at least one aspect of a vehicle and/or any other suitable application described herein and/or any other suitable application.

The system 200 may multiply a respective input of a layer of a neural network by each entry of the plurality of entries of the codebook. The system 200 may determine, for the respective input of the layer of the neural network, an intermediate value based on a sum of each result of multiplying the respective layer of the neural network by each entry of the plurality of entries of the codebook.

The system 200 may store the intermediate value associated with the respective input of the layer of the neural network in a lookup table. The lookup table may include a plurality of intermediate values corresponding to other inputs of the layer of the neural network. The system 200 may determine each output of the layer of the neural network using the lookup table.

It should be understood that the systems and methods described herein may be configured to perform any suitable function, such as those described herein with respect to FIGS. 6-11.

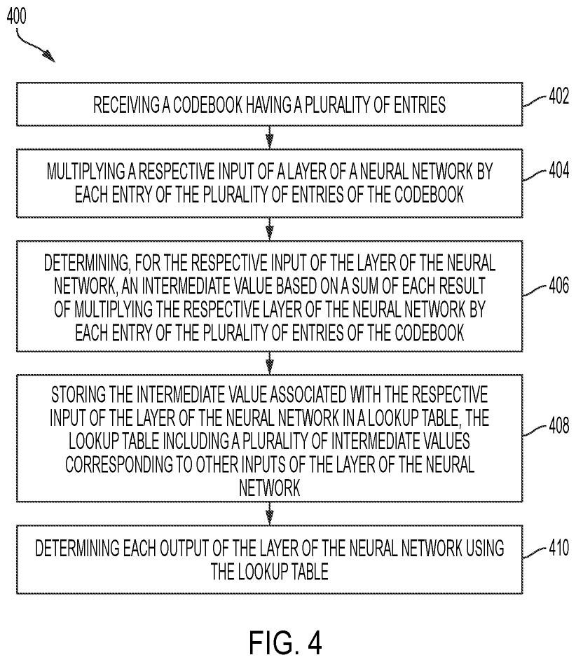

FIG. 4 is a flow diagram generally illustrating neural network computations method 400 according to the principles of the present disclosure. At 402, the method 400 receives a codebook having a plurality of entries. For example, the system 200 may receive the codebook.

At 404, the method 400 multiplies a respective input of a layer of a neural network by each entry of the plurality of entries of the codebook. For example, the system 200 may multiply the respective input of the layer of the neural network by each entry of the plurality of entries of the codebook.

At 406, the method 400 determines, for the respective input of the layer of the neural network, an intermediate value based on a sum of each result of multiplying the respective layer of the neural network by each entry of the plurality of entries of the codebook. For example, the system 200 may determine the intermediate value.

At 408, the method 400 stores the intermediate value associated with the respective input of the layer of the neural network in a lookup table. For example, the system 200 may store the intermediate value in the lookup table. The lookup table may include a plurality of intermediate values corresponding to other inputs of the layer of the neural network.

At 410, the method 400 determines each output of the layer of the neural network using the lookup table. For example, the system 200 may determine each output of the layer of the neural network using the lookup table.

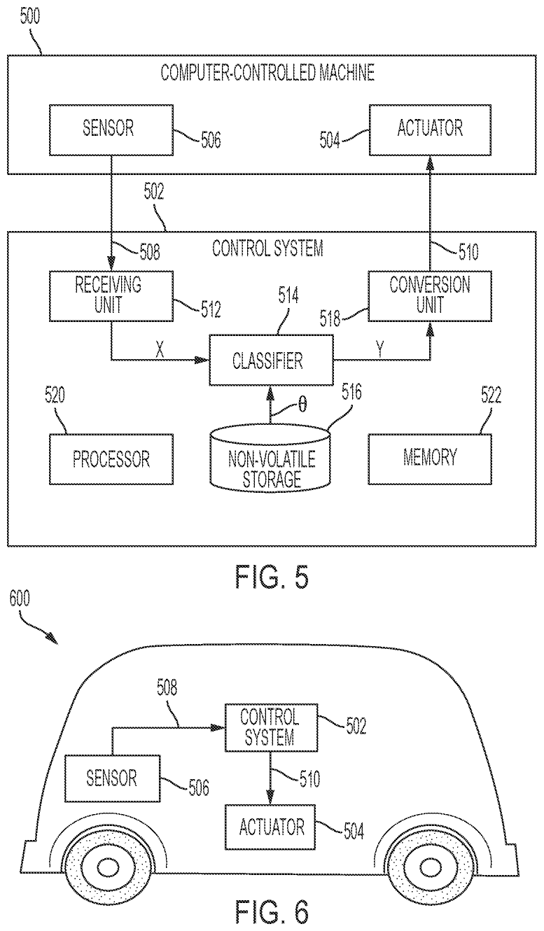

FIG. 5 depicts a schematic diagram of an interaction between computer-controlled machine 500 and control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, ultrasonic and motion sensors. In some embodiments, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes classifier 514. Classifier 514 may be configured to classify input signals x into one or more labels using a machine-learning (ML) algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In some embodiments, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In some embodiments, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., ML algorithms) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more ML algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the ML algorithms and/or methodologies as disclosed herein. Non-volatile storage 516 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, radar sensors, ultrasonic sensors, LiDAR sensors, and/or position sensors (e.g. GPS). One or more of the one or more specific sensors may be integrated into vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects.

In some embodiments, the vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In some embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In some embodiments, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

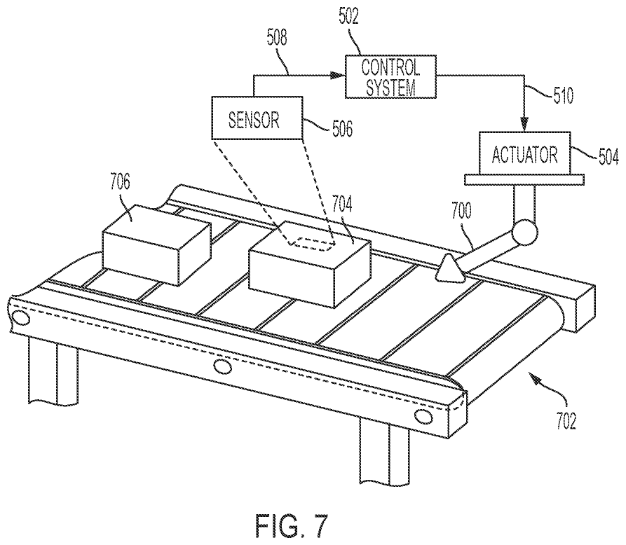

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 706 of system 700 (e.g., manufacturing machine) depending on the determined state of manufactured product 704.

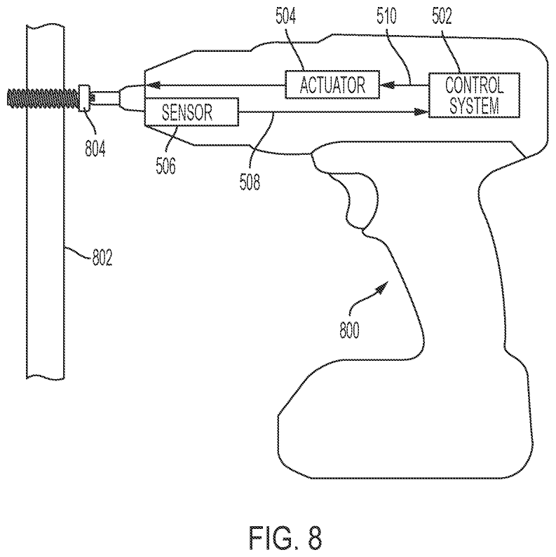

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

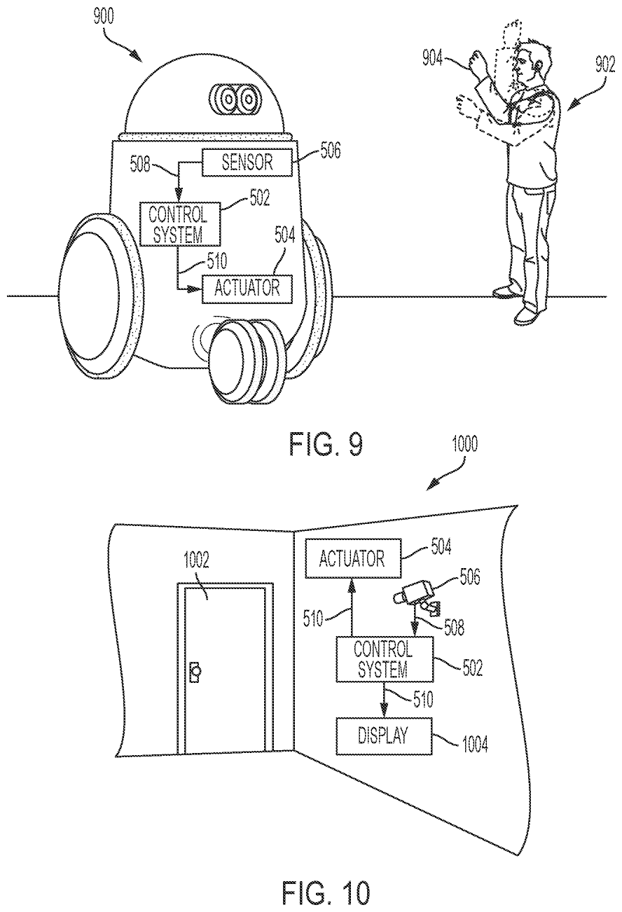

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In some embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

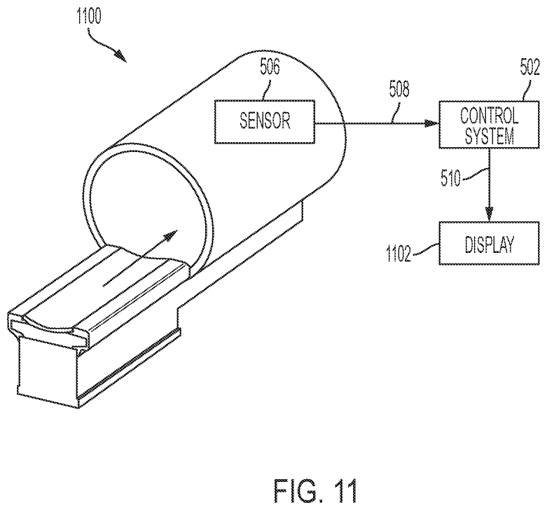

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 1102 to display the imaging and highlighting the potentially anomalous region.

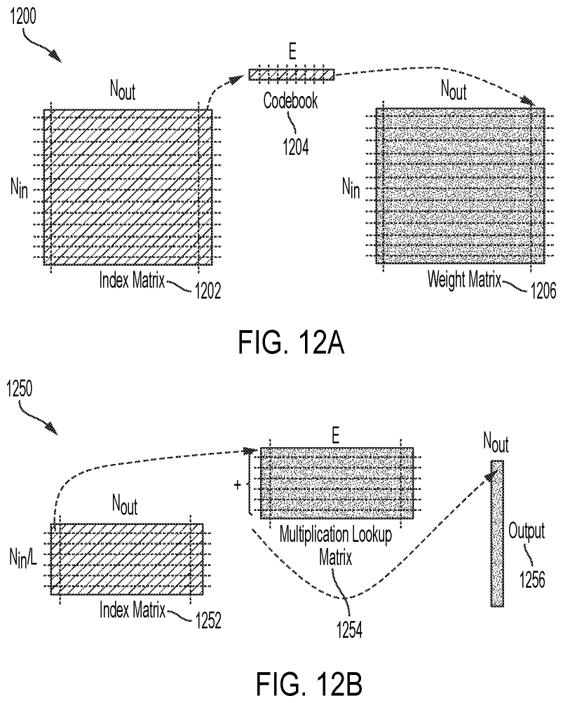

FIG. 12A depicts a diagram 1200 of a vector quantized linear system, in accordance with the present disclosure. In some embodiments, the diagram 1200 includes an index matrix 1202 may include the model parameters of the neural model. The index matrix 1202 may work in conjunction with codebook 1204 where the codebook has E entries, each of size 1. The index matrix 1202 works in conjunction with the codebook 1204 to produce the intermediate results in weight matrix 1206. Each parameter in the weight matrix 1206 is an entry in the codebook 1204. Once weight matrix 1206 is generated based on index matrix 1202 and codebook 1204, the weight matrix 1206 can function as a normal linear layer in the neural model. Herein, storage space required may be expressed as 4*E+Nin*Nout and processing power required may be expressed as Flops=Nin*Nout.

FIG. 12B depicts a diagram 1250 of a vector quantization linear system, in accordance with the present disclosure. In some embodiments, the diagram 1250 includes an index matrix 1252 of model parameters. In some embodiments, the diagram 1250 may further include multiplication lookup matrix 1254 of intermediate results. To generate the multiplication lookup matrix 1254, each L consecutive input value is multiplied to all codebook entries and each L value is summed. To generate the output 1256, a look-up process is executed based on the multiplication lookup matrix 1254.

In some embodiments, a method for generating vector-quantized deep neural networks includes: receiving a training dataset that includes one or more images; training a neural model with the training dataset to generate a first layer having weighted parameters; dividing the first layer into a first predetermined number of segments based on the first layer being a first type of layer; generating a codebook by replacing the weighted parameters in each segment of the first layer with a codeword based on finding a representative vector which most closely relates to the weighted parameters of each segment in a vectorization dictionary, wherein the codebook includes a number of codewords equal to the first predetermined number of segments and each codeword includes the representative vector; and in response to updating the neural model with the codebook, outputting a trained neural model that includes the codebook which replaces the first layer.

In some embodiments, the method also includes: dividing a second layer into a second predetermined number of segments, based on the second layer being a second type of layer. In some embodiments, the method also includes: updating the codebook by replacing the weighted parameters in each segment of the second layer with the codeword based on finding the representative vector which most closely relates to the weighted parameters of each segment in the vectorization dictionary; and, in response to updating the codebook, outputting the trained neural model that includes the codebook which replaces the first and second layer. In some embodiments, the method also includes: pruning redundant parameters from the neural model based on the codebook. In some embodiments, the first type of the first layer can be at least one of: a linear layer, a 1×1 convolution layer, and a 3×3 convolution layer. In some embodiments, the first layer is a linear type of layer and the first predetermined number of segments is 8. In some embodiments, the second layer is a convolution type of layer and the second predetermined number of segments is 16. In some embodiments, after training and vectorization, the neural model is utilized by at least one of: a mobile device, an internet of things device, a wearable device. In some embodiments, the segments of the first layer do not overlap. In some embodiments, the one or more images are at least one of: numbers, text, audio, vector image, bitmap image, and sensor signal.

In some embodiments, a device for generating vector-quantized deep neural networks comprising one or more processors configured to: receive a training dataset that includes one or more images; train a neural model with the training dataset to generate a first layer having weighted parameters; divide the first layer into a first predetermined number of segments based on the first layer being a first type of layer; generate a codebook by replacing the weighted parameters in each segment of the first layer with a codeword based on finding a representative vector which most closely relates to the weighted parameters of each segment in a vectorization dictionary, wherein the codebook includes a number of codewords equal to the first predetermined number of segments and each codeword includes the representative vector; and, in response to updating the neural model with the codebook, output a trained neural model that includes the codebook which replaces the first layer.

In some embodiments, the one or more processors are further configured to: divide a second layer into a second predetermined number of segments, based on the second layer being a second type of layer. In some embodiments, the one or more processors are further configured to: update the codebook by replacing the weighted parameters in each segment of the second layer with the codeword based on finding the representative vector which most closely relates to the weighted parameters of each segment in the vectorization dictionary; and, in response to updating the codebook, output the trained neural model that includes the codebook which replaces the first and second layer. In some embodiments, after training and vectorization, the neural model is utilized by at least one of a mobile device, an internet of things device, a wearable device. In some embodiments, the segments of the first layer do not overlap. In some embodiments, the one or more images are at least one of numbers, text, audio, vector image, bitmap image, and sensor signal.

In some embodiments, a system for generating vector-quantized deep neural networks comprising one or more processors configured to: receive a training dataset that includes one or more images; train a neural model with the training dataset to generate a first layer having weighted parameters; divide the first layer into a first predetermined number of segments based on the first layer being a first type of layer; generate a codebook by replacing the weighted parameters in each segment of the first layer with a codeword based on finding a representative vector which most closely relates to the weighted parameters of each segment in a vectorization dictionary, wherein the codebook includes a number of codewords equal to the first predetermined number of segments and each codeword includes the representative vector; and, in response to updating the neural model with the codebook, output a trained neural model that includes the codebook which replaces the first layer.

In some embodiments, the one or more processors are further configured to: divide a second layer into a second predetermined number of segments, based on the second layer being a second type of layer. In some embodiments, the one or more processors are further configured to: update the codebook by replacing the weighted parameters in each segment of the second layer with the codeword based on finding the representative vector which most closely relates to the weighted parameters of each segment in the vectorization dictionary; and, in response to updating the codebook, output the trained neural model that includes the codebook which replaces the first and second layer. In some embodiments, the first type of the first layer can be at least one of a linear layer, a 1×1 convolution layer, and a 3×3 convolution layer.

In some embodiments, a method for neural network computations includes receiving a codebook having a plurality of entries, multiplying a respective input of a layer of a neural network by each entry of the plurality of entries of the codebook, and determining, for the respective input of the layer of the neural network, an intermediate value based on a sum of each result of multiplying the respective layer of the neural network by each entry of the plurality of entries of the codebook. The method also includes storing the intermediate value associated with the respective input of the layer of the neural network in a lookup table, the lookup table including a plurality of intermediate values corresponding to other inputs of the layer of the neural network. The method also includes determining each output of the layer of the neural network using the lookup table.

In some embodiments, the codebook has a dimension corresponding to a number of inputs of the layer of the neural network. In some embodiments, each entry of the plurality of entries of the codebook corresponds to an index value. In some embodiments, each index value is an integer between 1 and an upper limit. In some embodiments, the upper limit corresponds to a total number of entries of the plurality of entries of the codebook. In some embodiments, the layer of the neural network is one of a plurality of linear layers of the neural network. In some embodiments, the layer of the neural network includes a fully connected layer. In some embodiments, the neural network includes a convolutional neural network. In some embodiments, the neural network includes a vector-quantized deep neural network. In some embodiments, the neural network is associated with controlling at least one aspect of a vehicle.

In some embodiments, a system for neural network computations includes a processor, and a memory. The memory includes instructions that, when executed by the processor, cause the processor to: receive a codebook having a plurality of entries; multiply a respective input of a layer of a neural network by each entry of the plurality of entries of the codebook; determine, for the respective input of the layer of the neural network, an intermediate value based on a sum of each result of multiplying the respective layer of the neural network by each entry of the plurality of entries of the codebook; store the intermediate value associated with the respective input of the layer of the neural network in a lookup table, the lookup table including a plurality of intermediate values corresponding to other inputs of the layer of the neural network; and determine each output of the layer of the neural network using the lookup table.

In some embodiments, the codebook has a dimension corresponding to a number of inputs of the layer of the neural network. In some embodiments, each entry of the plurality of entries of the codebook corresponds to an index value. In some embodiments, each index value is an integer between 1 and an upper limit. In some embodiments, the upper limit corresponds to a total number of entries of the plurality of entries of the codebook. In some embodiments, the layer of the neural network is one of a plurality of linear layers of the neural network. In some embodiments, layer of the neural network includes a fully connected layer. In some embodiments, the neural network includes a convolutional neural network. In some embodiments, the neural network includes a vector-quantized deep neural network.

In some embodiments, an apparatus includes a processor, and a memory. The memory includes instructions that, when executed by the processor, cause the processor to: retrieve a codebook having a plurality of entries and a dimension corresponding to a number of inputs of a layer of a neural network, wherein the neural network includes a vector-quantized deep neural network; multiply a respective input of the layer of the neural network by each entry of the plurality of entries of the codebook; determine, for the respective input of the layer of the neural network, an intermediate value based on a sum of each result of multiplying the respective layer of the neural network by each entry of the plurality of entries of the codebook; store the intermediate value associated with the respective input of the layer of the neural network in a lookup table, the lookup table including a plurality of intermediate values corresponding to other inputs of the layer of the neural network; and determine each output of the layer of the neural network using the lookup table.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for neural network computations, the method comprising:
receiving a codebook having a plurality of entries;
multiplying a respective input of a layer of a neural network by each entry of the plurality of entries of the codebook;
determining, for the respective input of the layer of the neural network, an intermediate value based on a sum of each result of multiplying the respective layer of the neural network by each entry of the plurality of entries of the codebook;
storing the intermediate value associated with the respective input of the layer of the neural network in a lookup table, the lookup table including a plurality of intermediate values corresponding to other inputs of the layer of the neural network; and
determining each output of the layer of the neural network using the lookup table.

2. The method of claim 1, wherein the codebook has a dimension corresponding to a number of inputs of the layer of the neural network.

3. The method of claim 1, wherein each entry of the plurality of entries of the codebook corresponds to an index value.

4. The method of claim 3, wherein each index value is an integer between 1 and an upper limit.

5. The method of claim 4, wherein the upper limit corresponds to a total number of entries of the plurality of entries of the codebook.

6. The method of claim 1, wherein the layer of the neural network is one of a plurality of linear layers of the neural network.

7. The method of claim 1, wherein the layer of the neural network includes a fully connected layer.

8. The method of claim 1, wherein the neural network includes a convolutional neural network.

9. The method of claim 1, wherein the neural network includes a vector-quantized deep neural network.

10. The method of claim 1, wherein the neural network is associated with controlling at least one aspect of a vehicle.

11. A system for neural network computations, the system comprising:
a processor; and
a memory including instructions that, when executed by the processor, cause the processor to:
receive a codebook having a plurality of entries;
multiply a respective input of a layer of a neural network by each entry of the plurality of entries of the codebook;
determine, for the respective input of the layer of the neural network, an intermediate value based on a sum of each result of multiplying the respective layer of the neural network by each entry of the plurality of entries of the codebook;
store the intermediate value associated with the respective input of the layer of the neural network in a lookup table, the lookup table including a plurality of intermediate values corresponding to other inputs of the layer of the neural network; and
determine each output of the layer of the neural network using the lookup table.

12. The system of claim 11, wherein the codebook has a dimension corresponding to a number of inputs of the layer of the neural network.

13. The system of claim 11, wherein each entry of the plurality of entries of the codebook corresponds to an index value.

14. The system of claim 13, wherein each index value is an integer between 1 and an upper limit.

15. The system of claim 14, wherein the upper limit corresponds to a total number of entries of the plurality of entries of the codebook.

16. The system of claim 11, wherein the layer of the neural network is one of a plurality of linear layers of the neural network.

17. The system of claim 11, wherein the layer of the neural network includes a fully connected layer.

18. The system of claim 11, wherein the neural network includes a convolutional neural network.

19. The system of claim 11, wherein the neural network includes a vector-quantized deep neural network.

20. An apparatus comprising:
a processor; and
a memory including instructions that, when executed by the processor, cause the processor to:
retrieve a codebook having a plurality of entries and a dimension corresponding to a number of inputs of a layer of a neural network, wherein the neural network includes a vector-quantized deep neural network;
multiply a respective input of the layer of the neural network by each entry of the plurality of entries of the codebook;
determine, for the respective input of the layer of the neural network, an intermediate value based on a sum of each result of multiplying the respective layer of the neural network by each entry of the plurality of entries of the codebook;
store the intermediate value associated with the respective input of the layer of the neural network in a lookup table, the lookup table including a plurality of intermediate values corresponding to other inputs of the layer of the neural network; and
determine each output of the layer of the neural network using the lookup table.
